(19) United States
(12) Patent Application Publication
(10) Pub. No.: US 2012/0015576 A1
(43) Pub. Date: Jan. 19, 2012

(54) Antimicrobially Treated and/or Stain-Repellant Planar Substrates and Method for Producing the Same

(76) Inventors: Sabine Amberg-Schwab, Erlabrunn (DE); Annett Halbhuber, Scheinfeld (DE); Detlev Uhl, Kitzingen (DE); Karl-Heinz Haas, Wurzburg (DE)

(21) Appl. No.: 13/257,312

(22) PCT Filed: Mar. 18, 2010
(86) PCT No.: PCT/EP10/53579

§ 371 Date: Sep. 19, 2011

(30) Foreign Application Priority Data
Mar. 19, 2009 (DE) 10 2009 013 884.6

(51) Int. Cl. B32B 9/00; B32B 5/02; B82Y 30/00; B82Y 40/00

(52) U.S. Cl. 442/93; 427/387; 442/59; 442/111; 442/123; 977/752; 977/750; 977/778; 977/892; 977/847; 977/961

(57) ABSTRACT

The invention relates to a planar or shaped textile material comprising or constituted of fibers, at least part of the fibers being coated with a hydrolytically condensed inorganic/organic hybrid material having single-walled or multi-walled carbon nanotubes which are embedded therein, optionally covalently bound thereto. The carbon nanotubes are preferably functionalized, especially with carboxylic acid groups or sulfanilic acid groups. The textile material is suitable for producing protective clothing, barrier materials or the like. The invention further relates to the use of the above-defined hybrid material as a coating material which imparts stain-resistance and/or antimicrobial properties to the coated substrate.

The present invention concerns flat substrates and in particular textile materials that exhibit an antimicrobial impregnation. This impregnation is comprised preferably of activated carbon nanotubes (CNTs) that are embedded in a matrix of inorganic-organic hybrid polymers (e.g. an ORMOCER®) and in special cases are covalently bonded thereto. The hybrid polymers comprise an inorganic network as well as organic components. In preferred embodiments they may carry organic groups that, optionally with the aid of heat or actinic radiation (e.g. UV radiation) or redox-catalyzed, are organically post-polymerized or post-polymerizable.

It is known to employ carbon nanotubes (single-wall tubes, SWNT, or multi-wall tubes, MWNT) as components of composites in order to reinforce them mechanically or in order to impart to them electrical conductivity or thermal conductivity (see Review Macromolecules 2006, pp. 5194-5205 (2870)). They can also be employed as actuators (Jain S. et al “Building smart materials using carbon nanotubes” Proc. SPIE Smart Structures and Materials 2004: Smart Electronics, MEMS, BioMEMS, and Nanotechnology pp. 167-175, vol. 5389 (2004)) or in aligned form e.g. for displays or microelectronic applications. Dispersions of CNT are commercially available (e.g. company BYK in cooperation with Bayer), also partially with reactive functions. A study of suitable surface-active agents for such dispersions was published by R. Rastogi et al. in Journal of Colloid and Interface Science 328 (2008) 421-428.

Inorganic-organic hybrid polymers are known in a plurality of variants, for example, as multi-functional scratch-resistant layers that can often be structured by UV. An important group of inorganic-organic hybrid polymers are organically modified (hetero) polysiloxanes that can be obtained by a sol-gel process. They are known in a large range of variations. Basic components of these materials are, in addition to tetraalkoxysilanes, primarily organically modified silicon compounds of the type R′Si(OR)₃ and R′₂Si(OR)₂ wherein R can be e.g. alkyl and R′ can be e.g. R or aryl or an organically cross-linkable or substituted organic residue. Examples are groups R′ that have one or several acrylate or methacrylate groups, anhydride, vinyl, allyl, epoxy or carboxylic acid (derivative) residues. By targeted hydrolysis of these precursors and condensation of the formed silanol groups an inorganic network is built. It can be expanded by the use of alkoxy compounds of certain metals such as aluminum, titanium or zirconium. In this way, a targeted influencing of physical matrix properties such as hardness, refractive index, and density is possible. An important effect on the material properties is also exerted by the type of employed organic modification. Non-reactive groups such as alkyl or phenyl residues serve as network modifiers and enable the adjustment of polarity and density of the matrix without changing the network density. With reactive groups (such as vinyl, methacryl or epoxy residues) that function as network formers, by photochemical or thermally induced polymerization reactions an additional organic network can be built. Covalent bonds exist between the inorganic and the organic phases. The coating sols that are obtained by sol-gel process can be applied by means of conventional lacquer application methods onto various substrates. Fields of application of the hybrid polymers comprise for example scratch-resistant and wear-resistant coatings of plastic surfaces, passivation layers for microelectronic elements, layers with antistatic and antiadhesive properties, with anti-soiling effect, with barrier effect relative to gases, vapors and volatile organic substances but also the use as compact materials in the dental field. Also, hybrid polymers lend themselves to the physical incorporation of functional inorganic, organic and bioorganic molecules that may function, for example, as gas, pH, ion and biosensors or as light dosimeter (see e.g. DE 196 50 286 C1; EP 0 792 846 A2; DE 196 07 524.6; DE 196 15 192 A1; EP 0 802 218 A2; DE 196 15 192.9).

Carbon nanotubes (nanotubes: in the following referred to as CNT) have already been incorporated in the past into organic lacquers (example polyimides) for TCO that are thermally curable; see company brochure of the company Eikos, Paul J. Glatkowski, “Carbon nanotube based transparent conductive coatings” 2004, in particular also FIG. 5. Internet information on Eikos is accessible at www.eikos.com. In this publication polyimides filled with SWNTs (single-wall nanotubes) with a degree of filling of approximately 0.05% by weight are compared with the same material with a degree of filling of >5% by weight of ITO particles with the result that the not yet optimized products in their properties (good transmission at 550 nm, low surface resistance) already come very close to those of ITO-filled material so that, with further improvements of the material constitution and the coating methods, at least equivalent products are to be expected.

Also known are: CNT-2D or 3D arrays produced by using a colloid that has been treated with sol-gel technology, see U.S. Pat. No. 6,749,712B2; a coating of FET (field effect transistors) with a semi-conducting layer of glycerin-crosslinked functionalized COOR—CNT in the area between the source electrode and the gate electrode, see U.S. 2006/0138404 A1; CNTs in combination with Ormocer®s for the coating of golf balls also in combination with layer silicates (barrier), see US 2006/0189412 A1; an electrically conducting composition produced from inorganic sol-gel with LF CNTs, see US 2006/0240238 A1 (DuPont).

Application possibility of CNT dispersions or composites, incorporated e.g. into polymer materials, are moreover spun fibers for textile materials (WO 2004/090204), materials that make surfaces antistatic and antiadhesive (WO 2008/046165, EP 1914277 A1) and polysiloxane-based compositions that are suitable as coatings for preventing the attachment of marine organisms on surfaces that are exposed to seawater. The polysiloxane used for this is commercially obtainable; it is an addition product of a polyhydrosilane and a polysilane that has a vinyl groups. The polysiloxane is filled with cylindrical nanofillers that may be sepiolite or carbon nanotubes (WO 2008/046166 A2).

DE 102008039129.8 describes new coating materials that are in the form of dispersions of de-agglomerated carbon nanotubes in polysiloxane matrices with an improved anchoring of the nanotubes in the matrices. These dispersions may contain particularly high quantities of nanotubes.

According to DE 102008039129.8 for the production of coating materials nanotubes (CNTs) are used to which are coupled functional groups. This provides improved dispersion in the corresponding matrix and thus the possibility to achieve higher solids content. In a preferred way, in this connection ultrasound and/or strong shearing gradients can be employed as de-agglomeration methods. For dispersion the use of adsorbing surface active agents and polyelectrolytes is possible.

Object of the present invention is to make surfaces of any flat substrates and in particular textile materials stain-resistant and/or antimicrobial. In this connection, the invention provides appropriately treated textile materials, for example, for protective clothing or barrier materials, as well as coating materials that are suitable for stain-resistant or antimicrobial treatment.

The object is solved, on the one hand, by providing flat or appropriately shaped textile materials whose fibers have a coating containing a hydrolytically condensed, preferably organically crosslinkable or organically crosslinked inorganic-organic hybrid material as well as preferably functionalized, single-wall or multi-wall carbon nanotubes dispersed therein. The invention also provides an appropriate method for producing these materials. In this connection, a suitable textile material is treated with a suspension that contains a hydrolytically condensed preferably inorganically post-curable and/or organically post-crosslinkable inorganic-organic polymer matrix (lacquer matrix) as well as preferably functionalized, single-wall or multi-wall carbon nanotubes dispersed therein or covalently bonded therein. This suspension is in the following also referred to as lacquer. The treatment can be done in any suitable form known in the prior art, e.g., by impregnation, spraying, submersion, or coating. After the treatment of the textile material excess lacquer, if present, is removed and the material is dried whereupon the lacquer cures, preferably with organic polymerization of organic groups present in the material, wherein the aforementioned inorganic-organic hybrid polymer material is produced.

On the other hand, the object of the invention is solved in that the aforementioned described lacquers are proposed for use as coating materials for flat substrates that impart to these substrates stain-resistant and/or antimicrobial properties. These flat substrates may be also textile material but also any other flat substrates are to be encompassed by the invention, in particular flexible plastic films that can be stored e.g. as endless material, i.e., in roll form.

Numerous textile materials and other flat materials suitable for the present invention are known. Textiles can be constituted of materials of various kinds, e.g. natural fibers (cellulose fibers, cotton), organic polymers, inorganic-organic mixed polymers, glass fibers, metal or ceramic fibers, mixed fibers of the materials or mixtures thereof. They can exist in forms of various kinds and e.g. can be treated with substances that impart in a targeted way certain properties. They can, but must not be, high-temperature resistant and/or may be present in a more or less compressed form. The porosity can be adjusted by various measures, e.g. by impregnation of the fibers with envelopes that make the fibers thicker and thus the pores smaller or by providing porous, optionally hollow, fibers. The pore size can be continuous throughout the textile material or can be varied throughout the thickness of the material in a target way. The pore size, depending on the application purpose, is adjusted in a suitable way. All types of textiles of the aforementioned materials, for example, woven material produced of yarns or other threads or knitted materials or laid fiber materials, are suitable. In the latter, the fibers in general are connected with each other either by needling or by other mechanical measures and/or by gluing. When the fibers have thermoplastic properties, fusing can be effected by heating the fibers; alternatively or additionally, they can be connected by means of an adhesive suspension with which the laid material, e.g. felt material, was impregnated. The term “shaped textile materials” in the meaning of the present invention is also meant to encompass yarns or still unspun or unlaid fibers. The invention is suitable however not only for textiles but also for other flat materials, for example, continuous or perforated films of plastic materials. Examples therefor are polyethylene, polypropylene or polyethylene terephthalate films.

Most commercially available dispersions of CNTs (e.g. AquaCyl™ of the company Nanocyl) are water-based and have a high CNT concentration but the pH value is however usually in the alkaline range. When the pH value is changed (e.g. to below 7), the CNTs can re-agglomerate quickly. This causes several difficulties upon dispersion in matrices of various kinds. A modification of the CNTs but also the selection of suitable wetting and dispersing agents can facilitate incorporation into the lacquer matrix. Various tests have shown that e.g. DMF (dimethyl formamide), N-methyl-2-pyrrolidone (NMP) or propylene carbonate (PC) are excellent solvents for CNT dispersions. Since they however have a very high boiling point of 153° C., 203° C., and 242° C. and DMF also is considered poisonous they are suitable only to a limited extent for use in lacquer matrices such as those that are suitable for the present invention. A limiting factor for dispersion is also the high surface energy of CNTs. As soon as the CNT agglomerates are broken up e.g. by ultrasound treatment and the CNTs are present individually, the viscosity of the dispersion increases enormously. Therefore, the maximal concentration of CNTs in such dispersions is in general at approximately maximally 1% by weight, based on the total lacquer composition. CNT dispersions are also mostly not stable for long periods of time and often, after a short period of time, agglomerates are formed again. This can be prevented e.g. by surface active agents such as sodium dodecyl sulfate or Triton X-100 that also improve dispersion. However, these surface active agents foam strongly and moreover are not suitable for all lacquer systems.

The invention uses the fact that the CNTs can be significantly better incorporated into lacquers than in the aforementioned concentration when they are constituted of inorganic-organic hybrid material. The suspensions that are produced thereby can be applied onto fibrous or other surfaces and cured so that the CNTs are adhering fast and long-term on the respective surface, e.g. on a fiber or a thread. According to the invention, it has however also been found that the CNTs must be incorporated in significantly reduced quantities compared to carbon black in order to obtain comparable effects which may be caused by many of the individual CNTs, because of their length in the μm range, contacting each other in the lacquer matrix and therefore forming longer conductive areas. Without wanting to be tied down to a theory, the inventors assume that a permanent charge resulting therefrom across larger areas causes the inventively observed effect of the coating. Therefore, according to the invention possibly also transparent lacquers with the desired properties may be obtainable while lacquers that are filled with carbon black with otherwise the same properties are no longer transparent but opaque.

The invention also uses the fact that a significantly larger proportion of CNTs can be incorporated into the matrix when the CNTs are used in the form of functionalized carbon nanotubes. This expression, in the meaning of the present invention, is to be understood such that carbon atoms that are bonded to the nanotubes are converted into an organic group whereby these carbon atoms have been converted to the appropriate oxidation state. The simplest form of this functionalization is the oxidation to a COO⁻ group that can then be further reacted with conventional methods (esterification, amidification, and optionally also reduced in this context). Thus, if transparency is not so much desired but instead high effectiveness, the incorporation of functionalized CNTs is preferred even when the effect of functionalized CNTs relative to the incorporated quantity is somewhat less than that of the unfunctionalized CNTs. This may be caused by smaller CNT fragments being formed upon modification of the CNTs.

The functional groups of the CNTs can be present in charged form (e.g. as —COO⁻) or in neutral form (e.g. as —COOH).

In a preferred embodiment of the present invention, CNTs are used that are functionalized as follows: On conventional CNTs (as an example reference is being had to Industrial Grade Multiwalled CNT of the company Nanocyl, Belgium) a basic functionalization is performed with COOH groups. The functionalization is done in general according to standard methods, for example, by reaction of the CNTs at 40° C. for 3 h in a mixture of HNO₃ and H₂SO₄ (ratio 1:3) with stirring and ultrasound. After the reaction expediently a neutralization of the suspension in a basic solution (NaOH or KOH) is carried out with subsequent isolation and washing of the functionalized nanotubes by means of centrifugation or filtration. In this way, carboxylate-group modified nanotubes (in the following referred to as CNT-COOH) are obtained.

In a further preferred embodiment of the invention, CNTs are used that starting with the already COOH-group functionalized CNTs have been further reacted wherein either the COOH group was modified or further functional groups were produced on the walls of the nanotubes. The modification of the COOH group can be done with conventional reaction partners that react with carboxylic acid functions. For example, the carboxylic acid group can be esterified or amidified wherein, of course, the balance of the reaction as is conventional must be pushed toward the product e.g. by removing the produced water.

An example for such an amidification reaction is the reaction with sulfanilic acid. In this connection, the previously obtained (or commercially obtained) CNT-COOH is reacted with a salt (e.g. the sodium salt of sulfanilic acid) or an optionally modified sulfanilic acid and is reacted with a coupling agent, for example, N,N′-dicyclohexyl carbodiimide (DCC) in a suitable solvent (for example, DMF). The reaction is carried out with stirring and ultrasound at room temperature within a time period of 24 hours. The product, in the following referred to as CNT-sulf, is therefore produced in its salt form or as free sulfanilic acid derivative. It is isolated, washed and dried.

In the following the two above steps are illustrated schematically.

First Step: Functionalization with Carboxylic Acid Groups:

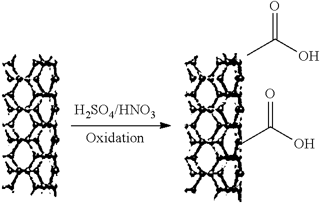

Second Step: Functionalization of the CNT-COOHs with Sulfanilic Acid:

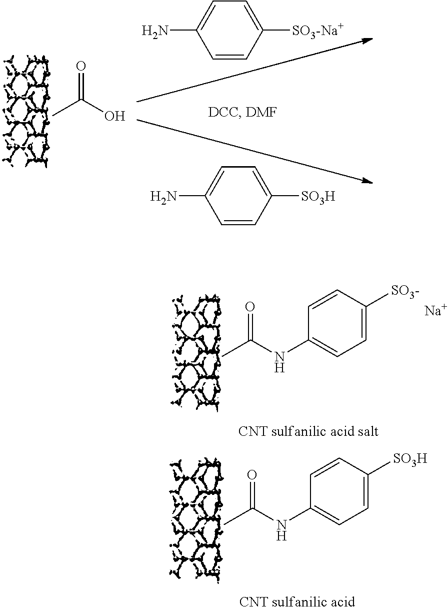

CNTs that are functionalized only with COOH groups (CNT-COOH) as well as CNT-COOH whose carboxylic acid residues have been further functionalized and in this connection in particular reacted with sulfanilic acid (in the following refer to as CNT-sulf) can be incorporated into inorganic-organic matrices (lacquers, hybrid polymers) of the aforementioned kind. For incorporation of the functionalized CNTs into the lacquer the CNTs in general must be de-agglomerated again and by means of stirring and optionally ultrasound must be stirred into the solvent associated with the lacquer or directly stirred into the lacquer. Solvent can be added as needed for adjusting the viscosity for producing a coating suspension for the purpose of the invention.

Since many applications of the textile materials according to the invention may be provided for areas where substances that are a health hazard should be avoided, aqueous solvents are preferred for the suspensions. For other areas, suspensions in solvents such as alcohol or the like can however be used without problems.

As a lacquer base for lacquers that are filled with functionalized CNTs a plurality of different materials on the basis of hybrid polymers of the aforementioned kind can be employed. For example, typical hybrid polymers can be used as they are also employed for barrier lacquers. They have generally a high degree of inorganic crosslinking. Also, it can be favorable to employ hybrid polymers that are still flexible after drying or curing. They are particularly preferred because textile materials impregnated therewith even after drying and optionally curing are still flexible so that already the fibers or threads that have not yet been converted into the final shape can be treated with the suspension according to the invention and only thereafter can be brought into the suitable shape.

The inorganic-organic hybrid polymers of the present invention are preferably produced to by use of silanes of the formula (I)

R¹ₐR²_{b}X_{4-a-b} (I)

wherein R¹ is a residue that is accessible for organic polymerization. The term “polymerization” is to be understood as a polyreaction in which the double bonds or the rings capable of reaction under the effect of heat, actinic radiations such as light or ionized radiation, optionally instead also redox-catalyzed, are converted to polymers (English: addition polymerization or chain growth polymerization). For example, a cationic polymerization can be realized by means of a cationic UV starter, for example with an epoxy system (see e.g. C. G. Roffey, Photogeneration of Reactive Species for UV Curing, John Wiley & Sons Ltd, (1997)). Examples for R are therefore residues with one or several non-aromatic C═C double bonds, preferably double bonds that are accessible by Michael addition such as styryls or (meth)acrylates. Alternatively, crosslinking can be realized by other polyreactions such as ring-opening polymerization. An example is the reaction of an epoxide residue with a residue that contains a carboxylic acid anhydride group. The residue R¹ contains in general at least two and preferably up to approximately 50 carbon atoms.

R² is (at least predominantly) an organic residue that is not accessible to organic polymerization. Preferably, it is an optionally substituted alkyl, aryl, alkylaryl or arylalky group whose substituents do not allow for crosslinking wherein the carbon chain of these residues optionally may be interrupted by O, S, NH, CONH, COO, NHCOO or the like. Preferred are residues R² with 1 to 30 but also up to 50, more preferred 6 to 25 carbon atoms.

X means OH or a leaving group that, under hydrolysis conditions, can be hydrolytically cleaved and at least partially, by bonding to an oxygen atom of a further silicon compound, contribute to inorganic crosslinking during the sol-gel formation. X can be in particular an alkoxy, hydrogen, hydroxy, acyloxy, alkyl carbonyl, alkoxy carbonyl and, in specific cases, also NR″₂ with R″ identical or different and with the meaning hydrogen or low alkyl (preferably with 1 to 6 carbon atoms). Preferably, X is an alkoxy group, and particularly preferred a C₁-C₄ alkoxy group.

a and b each can be 0, 1 or optionally also 2, 4-a-b can be in rare cases 1 but is in general 2 or 3. It is inventively preferred that the silanes used for producing the hybrid polymers at least partially are those in which a is 1 or, in rarer cases, 2, but a can also be 0 instead. The presence of a certain number of residues R² is also determinative for the properties of the lacquer; however, since R² as a network modifier affects the physical properties such as flexibility or density but does affect the degree of crosslinking, the number of b, depending on the desired properties, is selected appropriately.

The residues R¹ are also referred to as organic network formers because they enable the formation of an organic network in addition to the inorganic network formed by hydrolytic condensation. For this purpose, identical residues R¹ can react with each other, possible is also the reaction of different residues R¹, e.g of an epoxide with an amine residue or an (activated) acid residue with an alcohol residue. The residues X are referred to as inorganic network formers.

The hybrid material can be produced by use of at least one further silane of the formula (II)

SiX₄ (II)

wherein X can be identical or different and has the same meaning as in formula (I). A compound that is well-suited for this is tetraethoxysilane. By addition of such silanes to the mixture to be hydrolyzed and condensed of which finally the coating suspension is produced, the SiO proportion, i.e., the inorganic proportion, is increased.

Instead, or optionally additionally, the hybrid material usable according to the invention can be produced by use of at least one silane of the formula (III)

R¹ₐR²₃₋ₐX (III)

wherein R¹, R² and X have the meaning as explained above for formula (I). In this way, the organic proportion of the material is increased which may improve the elasticity of the material.

The hybrid materials of each of the aforementioned embodiments can optionally be further hydrolytically condensed by addition of further substances, e.g. of complexed or (chelate) ligand-containing metals of main group III, of germanium, and of metals of the transition metal groups II, III, IV, V, IV, VII, and VIII. Especially favorable are in particular boron, aluminum, zirconium, germanium or titanium compounds. Often for this purpose alkoxides, in particular C₁-C₆ alkoxides, are used which in the presence of complexing solvents are dissolved or obtained from such solution. Moreover, the starting materials may contain purely organic materials that can be polymerized into the organic network.

In particular zirconium alkoxides are preferred for the reasons explained in more detail in the following.

The starting materials are hydrolytically condensed or partially condensed according to the known sol-gel method wherein in general a catalyst initiates or accelerates the condensation reaction and optionally a suitable catalyst or initiator initiates or accelerates the organic polymerization. The sol-gel step is carried out in general in a suitable solvent, for the aforementioned reasons preferably on aqueous basis. The product is referred to frequently as lacquer. Subsequently, this lacquer is brought to the suitable viscosity, for example, by dilution. Subsequently, curing can be done by evaporation of the solvent, further inorganic post-crosslinking and/or organic crosslinking. Organic crosslinking can be realized by means of catalysts and/or initiators thermally, by means of actinic radiation (e.g. UV radiation) and/or redox-catalyzed. The inorganic post-crosslinking is frequently tied to evaporation of solvent. All this has been known for a long time and is disclosed in written form in numerous publications.

By variability of the employed starting materials as well as e.g of the degree of crosslinking of the prepolymers produced therefrom (that depends inter alia on the number of groups X in the silanes of the formula (I) or of the other additives) variation potential is available that can be utilized for producing various lacquers that are suitable for use with different surfaces and in particular in connection with textile materials.

For producing the suspensions usable according to the present invention in general approximately 0.2-20% by weight of non-functionalized or functionalized CNTs, based on the solids contents of the lacquer, are stirred into the latter and preferably dispersed by means of ultrasound. The quantity depends on the effect to be obtained, respectively, and can therefore be higher or lower. For example, an antimicrobial action in some cases can be obtained already for 1% by weight or even less. For other applications approximately 1.0 to 15 and preferably at least approximately 7.5, even more preferred at least approximately 10% by weight can be particularly favorable. For adaptation of the viscosity and for facilitating the de-agglomeration of the coating suspension it can be diluted frequently with deionized water and/or ethanol. In this connection, the functionalized CNTs are added usually to the lacquer after the hydrolytic condensation has been initiated; however they can be added also at an earlier point in time. It has been found that the CNTs can be dispersed in the lacquers especially well when they contain metal alcoholates or complexed metal compounds. In this way, very high contents of CNTs can be realized. In particular, the inventors were able to obtain good results in the presence of zirconium alcoholate (zirconium propylate): for example, in not yet optimized experiments, 1.2% by weight of sulfanilized CNTs, based on the total weight, can be incorporated without having to rely on dispersion agents. After optimization and/or with such an agent, it should be possible to increase the quantity even more. Conventional dispersion agents can be used in order to facilitate dispersion and to increase even more the quantity of incorporated CNTs. This applies in particular to water-based lacquers. They are preferred, on the one hand, because of environmental compatibility; on the other hand, however, they are also suitable in special cases especially for applications according to the invention because of the obtainable hardness of the post-cured product. Up to at least 0.5% by weight of CNT-sulf, based on the total weight of the lacquer, often however significantly more (e.g. up to more than 5% by weight CNT-sulf) can be incorporated into water-based lacquers that are not only acid-catalyzed but also have a pH value in the acid range.

Notable in this context is that already an addition of 0.1% by weight of sulfanilic acid-modified CNTs may enhance the hardness of such lacquers significantly (e.g. by approximately 30%).

In a specific embodiment of the invention functionalized CNTs are used that are bonded by their functional groups covalently in the lacquer. For example, the carboxylic acid group of carboxylated CNTs can react with free OH or NH₂ groups of the lacquer to ester or amid bonds. For this purpose, for example silanes with aminoalkyl or hydroxy alkyl groups are used in the lacquer base.

It should be noted that the presence of ammonium groups in the lacquer can be disadvantageous. Ammonium groups or other positively charged groups appear to interact with the functionalized CNTs so that the viscosity increases.

The crosslinking degree of the lacquers—the aforementioned lacquer types differ greatly with respect to inorganic and organic crosslinking—can have a great effect on the resulting system with the functionalized CNTs (e.g. a directionally selective orientation of the CNTs or percolation).

The provided textile or other flat material is treated with the suspension, e.g. by padding. For this purpose, it is impregnated with the suspension that is subsequently pressed out between two rollers. Subsequently, the lacquer, as described above, is cured.

With the coating materials of the present invention, as needed, very thin coatings can be obtained, for example, of below 5 μm, preferably below 2 μm, and in many cases even below 1 μm, that still have excellent properties, inter alia a greatly reduced surface resistance, as will be apparent e.g. from the examples. This is in particular—but not exclusively—important for textile materials because textiles when coated should be impaired as little as possible with respect to their haptic properties and their flexibility. A further advantage of thin layers is that their transparency is high. Thus, the coatings according to the invention can have a light transmission of significantly above 60%, mostly above 80% and frequently even of 85% to 90% or even above, in the visible range, depending on the thickness of the layer and the selected quantity of CNTs.

It has been demonstrated that textile materials that have been treated according to the invention have an antimicrobial action, namely already with minimal quantities of incorporated CNTs. For other purposes, higher quantities of CNTs are particularly beneficial so that a lacquer with a high quantity of in particular functionalized CNTs may be preferred. In comparison to antimicrobial substances commonly used until today such as octadecyl dimethyl (3-trimethoxy silyl propyl) ammonium chloride (OTA), the systems useable according to the invention have the advantage that they can be conceptualized with a solvent system that is suitable for the respective system because the optionally functionalized CNTs, independent of the selected solvent, can be incorporated into the resin matrix while the use of conventional substances requires the specific, usually toxicologically risky, solvent; OTA, for example, is offered in a 60% methanol solution.

By incorporation of CNTs in inorganic-organic matrices of the aforementioned kind and application on textile or other flat structures, the surface resistance is lowered by several orders of magnitude; excellent permanent electret properties are obtained. Probably for this reason at the same time antimicrobial as well as stain-resistant properties can be adjusted; also, the strong antistatic effect may be especially beneficial in combination with other properties in particular for protective clothing.

As a whole, according to the invention coatings or coated materials can be produced therefore that, despite the low degree of filling with CNT (and thus with high transparency), can have a more than satisfactory antimicrobial/stain-resistant action or—at higher degree of filling—are highly effective with regard to the aforementioned properties and in both situations, because of their minimal thickness, will not impair desirable properties of the coated material such as haptic feel or flexibility.

### EXAMPLE 1

A lacquer was produced from the following components:

1,140.3 mmol (85 mol-%; 347.12 g) of 3-(triethoxysilyl) propyl succinic acid anhydride, 201.7 mmol (15 mol-%; 89.43 g) Zr tetra-n-propylate 73.9%, 2/3 m, based on succinic acid anhydride, ethanol, 2,113.9 mmol 0.1 n HCl (approximately half stoichiometric; for hydrolysis; 38.09 g).

To the already provided silane the Zr-alcoholate and then ethanol were added with stirring. The resulting solution was yellow. Dropwise, hydrolyzation with acid was performed wherein 20° C. was not surpassed. Stirring was continued for 120 min. at RT wherein the solution turned almost colorless. The product had a solids contents of 41.68% by weight.

For the incorporation of the CNT-sulf the lacquer was first diluted to 10% by weight. Subsequently, the CNTs were dispersed therein. Based on the solids contents of the lacquer matrix, dispersions were produced with different proportions of CNTs up to a content of 12% by weight of CNT. The measurements presented in the following of the surface resistance or of the specific conductivities of coatings on films have shown that approximately beginning at a concentration of 7.5% by weight of CNT-sulf, based on the solids contents, excellent conductivities can be obtained. The examination of the antimicrobial action was also positive.

### 4-Point Conductivity Measurement:

For each sample 10 measurements were performed. Sample A had a CNT contents of 7.5% by weight, sample B one of 12% by weight, based on the solids contents.

The measured thickness of the samples was 100 μm; the spacing of the four measuring tips relative to each other was 2.77 mm.

The average measured resistance R (MΩ) was for sample A 10.03±4.2 and for sample B 2.13±0.6. From this resulted an estimated corrective factor of 1.0 for both samples. The resistance Rs=C×C1×U/l (with C=π/ln 2−4.53236) for sample A was 45.45 MΩ and for sample B 9.64 MΩ; the specific resistance ρ(=Rsxt) was calculated based thereon to 4,639 Ωm for sample A and 984 Ωm for sample B; the specific conductance σ(1/ρ) was 2.16E-04 for sample A and 1.02E-03 for sample B.

### Examination of Antimicrobial Action—Surface Resistance

The surface resistance of the samples was as follows:

surface resistance

| comparative sample | sample A |
|---|---|
| average value | average value |
| (Ohm) | (Ohm) |
| 3.60E+12 | 6.60E+06 |

The comparative sample was comprised of the same lacquer with the same dilution without CNTs.

It was also determined that samples A and B exhibited antimicrobial action.

The measurement of the surface resistances of the sample A, the sample B and the comparative sample was repeated by an electrometer/High Resistivity Fixture 8009 of the company Keithley. For this purpose, the samples in the form of a coating onto PET film, applied by means of a spiral applicator to 50 μm and subsequently cured thermally for 1 h at 130° C. without recirculating air, were clamped with the coating facing down between two electrodes. Subsequently a measuring voltage of 25 V was applied. The surface resistance was determined based on the current that flowed and indicated in Ohm per (specifically determined) surface area.

The surface resistance of the comparative sample was determined to 1.3E+14Ω/surface area, that of the sample A to 8.3E+6Ω/surface area and that of sample B to 7.5E+5Ω/surface area.

### EXAMPLE 2

A mixture of 3-(triethoxysilyl) propyl succinic acid anhydride and γ-glycidoxypropyl trimethoxy silane in a molar ration of 2:1 was carefully hydrolytically condensed in 25% by weight of butoxy ethanol, based on the weight of the silanes, in the presence of methyl imidazole as a catalyst. To the resulting sol in various batches 2 to 15% by weight of CNT-COOH, based on the solid contents of the sol (approximately 54%) were added and dispersed. During thermal curing of this lacquer system two anhydride residues add with formation of two free carboxylic acid groups at the epoxide residue that opens.

### EXAMPLE 3

### Water-Based Lacquer System

A further lacquer system was produced on the basis of aluminum tri(sec-butylate), Zr-n propylate, tetramethoxy silane and glycidyl propyl triethoxy silane. The hydrolysis was initiated with 0.1 n HCl. After condensation the solvent was removed by rotary evaporator and replaced with 0.1 HCl. Subsequently, dilution was carried out with water to a solids contents of 10% by weight.

With this lacquer system the following dispersions were produced:

### Dispersion I:

To 300 g of 10% by weight of the water lacquer 3 g Triton x 100 (octylphenol poly(ethylene glycol ether); non-ionic detergent) was added as a dispersion agent. The latter was dissolved therein with stirring. Subsequently, 5% by weight (1.5 g) carboxylated CNTs, based on the solids contents of the lacquer, were dispersed stepwise with an ultrasound finger in the lacquer.

### Dispersion II:

To 275 g of the 10% by weight water lacquer, first 1% (6.875 g, 40% in H₂O) of a high-molecular block copolymer with pigment-affinity groups (deflocculation agent) of the company Byk, Germany, was added and dissolved with stirring. Subsequently, 5% by weight (1.375 g), based on the solids contents of the lacquer, CNT-sulf was dispersed stepwise with ultrasound finger in this lacquer. An agglomerate-free dispersion that was uniformly dyed black was obtained into which further CNT-sulf could be incorporated.

### Dispersion III

To 275 g of the 10% water lacquer first 1% (6.875 g, 40% in H₂O) of a high-molecular block copolymer with pigment-affinity groups (deflocculation agent) of the company Byk, Germany, was added and was dissolved with stirring. Subsequently, 5% by weight (1.375 g), based on the solids contents of the lacquer, of unfunctionalized CNT was dispersed stepwise with ultrasound finger in this lacquer.

Dispersion III was applied as a wet film in a thickness of 10 μm and 20 μm onto PT film; as a comparison the same lacquer system without CNTs was applied in a thickness of 20 μm onto PET film. After drying/curing, performed as in Example 1 for the samples A and B, the thickness of the obtained dry films was <1 μm and ˜1.7 μm. The surface resistances were measured as described in connection with Example 1 by means of the electrometer of Keithley under the same conditions as described therein. In this connection, for the CNT-free sample a surface resistance of 9.4E+13 Ω/surface area, for the <1 μm thick sample a surface resistance of 2.5E+6Ω/surface area and for the ˜1.7 μm thick sample a surface resistance of one 1.2E+5Ω/surface area was determined.

Lowering of the surface resistance correlated with an increase of the antimicrobial action.

### EXAMPLE 4

A further lacquer system was produced similar to the way described in Example 3 with the modification that the zirconium-n-propylate was omitted. With this lacquer system the following dispersion was produced:

### Dispersion IV:

In the lacquer diluted with water/ethanol (1:1) to 10% by weight, 5% by weight of CNT-sulf was dispersed by means of ultrasound.

The dispersion IV as well as a comparative sample of the lacquer of this example without CNTs were applied as described above as a coating onto a PET film and after drying/curing measured by means of the electrometer of Keithley under the same conditions as described above. In this connection, for the CNT-free sample a surface resistance of E+14Ω/per surface area, for the dispersion IV a surface resistance of E+10Ω/surface area was determined.

Lowering of the surface resistance correlated with an increase of antimicrobial action.

What is claimed is:

1. A flat or shaped textile material comprising fibers, wherein the fibers are at least partially coated with a coating of hydrolytically condensed inorganic-organic hybrid material with single-wall or multi-wall carbon nanotubes embedded therein.

2. The textile material according to claim 1, wherein the inorganic-organic hybrid material contains organically polymerizable or organically polymerized groups.

3. The textile material according to claim 1, wherein the inorganic-organic hybrid material is obtainable or was obtained by use of at least one silane of the formula (I)
R¹ₐR²_{b}X_{4-a-b} (I)
wherein R¹ is identical or different and is a residue that is accessible for organic polymerization, R² is identical or different and is an organic residue that is not accessible to polymerization, X is identical or different and is OH or a leaving group that under hydrolysis conditions will cleave hydrolytically and at least partially can contribute, by bonding to an oxygen atom of a further silane compound, to inorganic crosslinking, wherein a and b each are 0, 1, or 2, and 4-a-b is 1, 2 or 3.

4. The textile material according to claim 3, wherein the hybrid material is obtainable or was obtained by use of at least one further silane of the formula (II)
SiX₄ (II)
and/or
at least one silane of the formula (III)
R¹ₐR²₃₋ₐX (III)
wherein R¹, R² and X optionally are the same or different and have, as does a, the meaning as indicated in claim 3 for formula (I).

5. The textile material according to claim 1, wherein the hybrid material was hydrolytically condensed with addition of at least one substance, selected from solvent-soluble or water soluble metal compounds or metal complexes of the main group III, of germanium and of metals of the transition metal groups II, III, IV, V, VI, VII, and VIII, wherein said metal compound/said metal complex preferably is selected from optionally complexed and/or chelate-ligand stabilized C₁-C₆ alkoxides of boron, aluminum, zirconium, germanium, and titanium.

6. The textile material according to claim 1, the hybrid material furthermore containing a purely organic material that preferably is present polymerized into the organic network.

7. The textile material according to claim 1, wherein the inorganic-organic hybrid material is free of cationic groups.

8. The textile material according to claim 1, wherein the carbon nanotubes are functionalized with neutral or ionic groups and in particular with carboxylic acid groups and/or with sulfanilic acid groups, wherein the sulfanilic acid groups are bonded by a carboxamide group to the carbon walls of the nanotubes.

9. The textile material according to claim 1, wherein the carbon nanotubes are functionalized with a functional group and incorporated covalently into the hybrid material with the functional group.

10. The textile material according to claim 1, containing at least 5.0% by weight, preferably at least 7.5% by weight and especially preferred at least 10% by weight of carbon nanotubes, based on the weight of the inorganic-organic hybrid material.

11. The textile material according to claim 1, wherein the hybrid material covalently adheres to the fibers.

12. The textile material according to claim 1 in the form of woven or knitted fabric, a yarn or a fabric insert.

13. The textile material according to claim 1, wherein the coating has a thickness of <5 μm, preferably of <2 μm, and especially preferred of 1 μm or less.

14. The textile material according to claim 1, wherein the coating has a surface resistance that is by a factor 10⁴, preferred by a factor 10⁵, more preferred by a factor 10⁶, and especially preferred by a factor 10⁷, lowered relative to the surface resistance of an otherwise identical textile material whose coating is free of CNTs.

15. A method for producing a textile material according to claim 3, comprising the steps:
producing a hydrolytic condensate from or by employing at least one silane of the formula (I) as defined in claim 3;
incorporating a suspension, containing single-wall or multi-wall carbon nanotubes;
applying the hydrolytic condensate provided with carbon nanotubes onto at least a portion of the surfaces of the fibers of a flat or shaped textile material; and
curing the hydrolytic condensate provided with the carbon nanotubes.

16. The method according to claim 15, wherein curing of the hydrolytic condensate comprises further inorganic crosslinking and/or crosslinking of organically polymerizable groups contained therein.

17. The method according to claim 15, wherein the hydrolytic condensate is produced in an aqueous solvent or, after having been produced, is transferred into an aqueous solvent.

18. The method according to claim 15, wherein the suspension of single-wall or multi-wall carbon nanotubes comprises functionalized nanotubes that preferably contain carboxylic acid and/or sulfanilic acid groups.

19. The method according to claim 15, comprising the step of adding, before incorporating the carbon nanotube suspension, a dispersion agent to the hydrolytic condensate.

20. A method of applying a hydrolytically condensed inorganic-organic hybrid material with embedded single-wall or multi-wall carbon nanotubes as a coating material on a flat substrate, wherein the coating material imparts to the coated substrate stain-resistant and/or antimicrobial properties.

21. The method according to claim 20, wherein the inorganic-organic hybrid material contains organically polymerizable or organically polymerized groups and preferably is obtainable or was obtained by use of at least one silane of the formula (I)
R¹ₐR²_{b}X_{4-a-b} (I)
wherein R¹ is identical or different and is a residue that is accessible for organic polymerization, R² is identical or different and is an organic residue that is not accessible to polymerization, X is identical or different and is OH or a leaving group that under hydrolysis conditions will cleave hydrolytically and at least partially can contribute, by bonding to an oxygen atom of a further silane compound, to inorganic crosslinking, wherein a and b are each 0, 1, or 2, and 4-a-b is 1, 2 or 3.

22. The method according to claim 21, wherein the hybrid material is obtainable or was obtained by use of at least one further silane of the formula (II)
SiX₄ (II)
and/or at least one additional silane of the formula (III)
R¹ₐR²₃₋ₐX (III)
wherein R¹, R² and X optionally are the same or different and have, as does a, the meaning as indicated in claim 20 for formula (I).

23. The method according to claim 20, wherein the hybrid material was hydrolytically condensed with addition of at least one substance, selected from solvent-soluble or water soluble metal compounds or metal complexes of the main group III, of germanium and of metals of the transition metal groups II, III, IV, V, VI, VII, and VIII, wherein said metal compound/said metal complex preferably is selected from optionally complexed and/or chelate-ligand stabilized C₁-C₆ alkoxides of boron, aluminum, zirconium, germanium, and titanium

24. The method according to claim 20, wherein the inorganic-organic hybrid material further contains a purely organic material that preferably is present polymerized into the organic network.

25. The method according to claim 20, wherein the inorganic-organic hybrid material is free of cationic groups.

26. The method according to claim 20, wherein the carbon nanotubes are functionalized with neutral or ionic groups and preferably with carboxylic acid groups and/or with sulfanilic acid groups wherein the latter are bonded by a carboxamide group to the carbon wall of the nanotubes.

27. The method according to claim 20, wherein the carbon nanotubes are functionalized and incorporated by a functional group covalently into the hybrid material.

28. The method according to claim 20, containing at least 5.0% by weight, preferably at least 7.5% by weight and especially preferred at least 10% by weight of carbon nanotubes, based on the weight of the inorganic-organic hybrid material.

29. The method according to claim 20, wherein the hybrid material was obtained from a hydrolytic condensate contained in water or in aqueous solvent.
